(19) United States
(12) Patent Application Publication
(10) Pub. No.: US 2023/0196184 A1
(43) Pub. Date: Jun. 22, 2023

(54) CROSS-LABEL-CORRECTION FOR LEARNING WITH NOISY LABELS

(71) Applicant: PayPal, Inc., San Jose, CA (US)

(72) Inventors: Yanfei Dong, Singapore (SG); Cha Hwan Song, Singapore (SG); Yichen Zhou, Singapore (SG)

(21) Appl. No.: 17/557,500

(22) Filed: Dec. 21, 2021

(51) Int. Cl. G06N 20/00

(52) U.S. Cl. CPC G06N 20/00

(57) ABSTRACT

In an embodiment, a first machine learning (ML) model is trained using a first portion of a training data set and a second ML model is trained using a second portion of the training data set. A prediction on data samples in the second portion by the first ML model is used to correct labels on noisy data samples in the second portion. A prediction on data samples in the first portion by the second ML model is used to correct labels on noisy data samples in the first portion. The first and second ML models are retrained after the labels of the noisy data samples have been replaced with corrective labels. After a number of iterations in retraining, the cross-label-correction may be performed again. After a certain number of cross-label-corrections, the training data in the first portion and the second portion is swapped to further train the models.

### TECHNICAL FIELD

The present disclosure generally relates to software architecture for machine learning and more particularly to technical improvements leading to better computer performance in cross-label correction for machine learning with noisy labels according to various embodiments.

### BACKGROUND

Machine learning and artificial intelligence techniques can be used to improve various aspects of decision making. Machine learning techniques often involve using available data to construct a model that can produce an output (e.g., a decision, recommendation, prediction, classification, etc.) based on particular input data. Training data (e.g., known, labeled, and/or previously classified data) may be used such that the resulting trained model is capable of rendering a decision on unknown data.

In general, deep neural networks and other machine learning algorithms are able to perform classification due to the available collections of massive, labeled datasets. However, it is time-consuming and expensive to collect high-quality, manual “ground truth annotations.” Less expensive sources to collect labeled data also exist, such as search engines, social media websites, or reducing the number of manual annotators per data sample. However, the low-cost approaches introduce low-quality annotations (e.g., labeling) with label noise. Training on noisy labeled datasets causes performance degradation because deep neural networks, and other machine learning algorithms that have a high learning capacity, will often overfit to the label noise. Therefore, there exists a need in the art for a robust algorithm for training deep neural networks, and other machine learning algorithms, when noisy labels are present.

### BRIEF DESCRIPTION OF THE FIGURES

FIG. 1 illustrates a flow diagram of a process for machine learning and noisy label correction in accordance with one or more embodiments of the present disclosure.

FIG. 2 illustrates a diagram of training a first machine learning model and a second machine learning model using a training data set in accordance with one or more embodiments of the present disclosure.

FIG. 3 illustrates a diagram of splitting the training data set into a first portion and a second portion, where the first portion may be used to further train the first machine learning model and the second portion may be used to further train the second machine learning model in accordance with one or more embodiments of the present disclosure.

FIG. 4 illustrates a diagram of running a prediction on data samples of the first portion of the training data set using the first machine learning model and running a prediction on data samples of the second portion of the training data set using the second machine learning model to identify noisy samples in the first portion and the second portion of the training data set in accordance with one or more embodiments of the present disclosure.

FIG. 5 illustrates a diagram of cross-feeding the noisy data samples from the first portion of the training data set to the second machine learning model and cross-feeding the noisy data samples from the second portion of the training data set to the first machine learning model, where the first machine learning model and second machine learning model then classify the noisy data samples in accordance with one or more embodiments of the present disclosure.

FIG. 6 illustrates a diagram of outputted classifications of the noisy data samples, which are used to identify corrective labels in accordance with one or more embodiments of the present disclosure.

FIG. 7 illustrates a diagram of relabeling the noisy data samples in the first and second portions of the training data set using the identified corrective labels in accordance with one or more embodiments of the present disclosure.

FIG. 8 illustrates a diagram of swapping data samples in the first and second portions of the training data set for further training the first and second machine learning models and correcting labels in accordance with one or more embodiments of the present disclosure.

FIG. 9 illustrates a block diagram of a networked system in accordance with one or more embodiments of the present disclosure is illustrated.

FIG. 10 illustrates a block diagram of a computer system implemented in accordance with one or more embodiments of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced using one or more embodiments. In one or more instances, structures and components are shown in block diagram form in order to avoid obscuring the concepts of the subject technology. One or more embodiments of the subject disclosure are illustrated by and/or described in connection with one or more figures and are set forth in the claims.

Deep learning techniques have advanced over the recent years to provide impressive results in classification tasks. However, such achievements have only been possible because of a large amount of labeled data that is currently available. Labeling data manually or by hand is laborious and inefficient in terms of time and cost. Therefore, automated/semi-automated techniques for generating labels have been developed. Automatic labeling may include user tags from social media websites, keywords from search engines (e.g., image searches), and other forms of collecting labeled data that is aggregated from a large number of users. However, such automated/semi-automated techniques generally result in an abundance of noisy labels because most of the “ground truth annotations” are provided by human labelers, who tend to make mistakes and increase biases of the data. Noisy labels may refer to incorrect labels on data samples or, in other words, labels that stray from a ground truth.

Learning from noisy labels significantly degrades model performances and remains a challenge in the field of machine learning. The cause of poor performance is generally due to overfitting the noisy label data. Overfitting may refer to a machine learning model that models the training data too well. Overfitting happens when a model learns the detail and noise in the training data to the extent that it negatively impacts the performance of the model when evaluating new data. In other words, the noise or random fluctuations in the training data is picked up and learned as concepts by the model, which is an issue because the concepts will not apply to new data and will negatively impact the model's ability to generalize.

The present disclosure provides systems and methods that allow for learning from noisy labels using cross-label-correction to reduce overfitting noisy labels. For example, in one embodiment, a computer system is provided. The computer system may initialize a first machine learning model and a second machine learning model. The computer system may train the first machine learning model and the second machine learning model using a training data set, which may contain noisy labels. The first machine learning model and the second machine learning model may be trained using the full training data set for a limited number of epochs to prevent early overfitting of noisy labels.

The computer system may then split the training data set into two portions, a first portion and a second portion. In some cases, the first portion and the second portion may each include approximately half of the full training data set. The computer system may train the first machine learning model with the first portion of the training data set and train the second machine learning model with the second portion of the training data set.

After training the first and second machine learning models with half of the full training data set for some iterations, the computer system may perform cross-label-correction. In the cross-label-correction, the computer system may run a first prediction on the first portion of the training data set using the first machine learning model and run a second prediction on the second portion of the training data set using the second machine learning model. From the first prediction, first noisy data samples may be identified and selected from the first portion based on their loss function values. For example, data samples from the first portion that have the largest losses according to a loss function may be identified and selected as the first noisy data samples. Similarly, from the second prediction, second noisy data samples may be identified and selected from the second portion based on their loss function values. For example, data samples from the second portion that have the largest losses according to a loss function may be identified and selected as the second noisy data samples.

The computer system may then cross-feed the first noisy data samples to the second machine learning model to have the second machine learning model classify the first noisy data samples. The computer system may identify classifications by the second machine learning model on the first noisy data samples that have the highest confidence scores and identify the labels for said classifications. The labels may be used as corrective labels to replace the previous training labels for the first noisy data samples.

Similarly, the computer system may cross-feed the second noisy data samples to the first machine learning model to have the first machine learning model classify the second noisy data samples. The computer system may identify classifications by the first machine learning model on the second noisy data samples that have the highest confidence scores and identify the labels for said classifications. The labels may be used as corrective labels to replace the previous training labels for the second noisy data samples.

Once the labels have been replaced on the noisy data samples in the first portion and the second portion, the first machine learning model may be trained again for a number of iterations using the first portion, and the second machine learning model may be trained again for the number of iterations using the second portion. The computer system may then perform the cross-label-correction again to further correct labels for data samples in the first and second portion of the training data set.

After a number of training and cross-label-correction iterations, the computer system may swap the data samples of the first portion and the second portion. Thus, the first machine learning model may be trained using the training data that previously comprised the second portion, and the second machine learning model may be trained using the training data that previously comprised the first portion. Again, the computer system may iterate through training the first machine learning model and second machine learning model and performing the cross-label-correction for a number of iterations until the data samples in the first portion and the second portion are swapped another time. The above process of retraining, correcting labels, and intermittently swapping may be repeated iteratively.

As resources are limited for perfect ground truth training data, the systems and methods disclosed herein provide an improvement in the technical field of machine learning by allowing noisy label data to be used to accurately learn models while simultaneously correcting the noisy label data, which can then be used as training data for additional machine learning purposes.

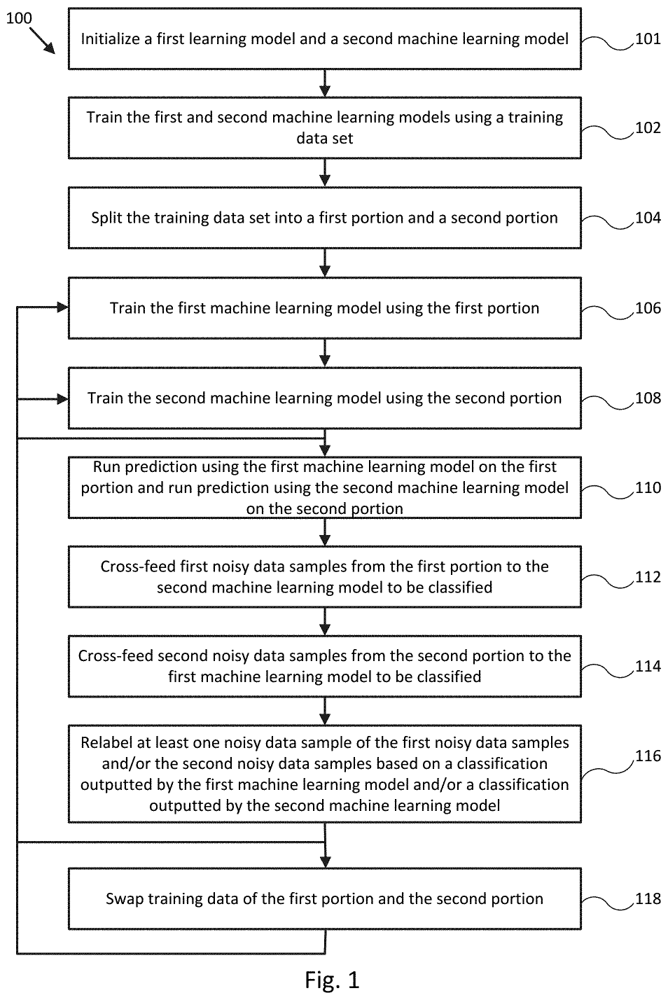

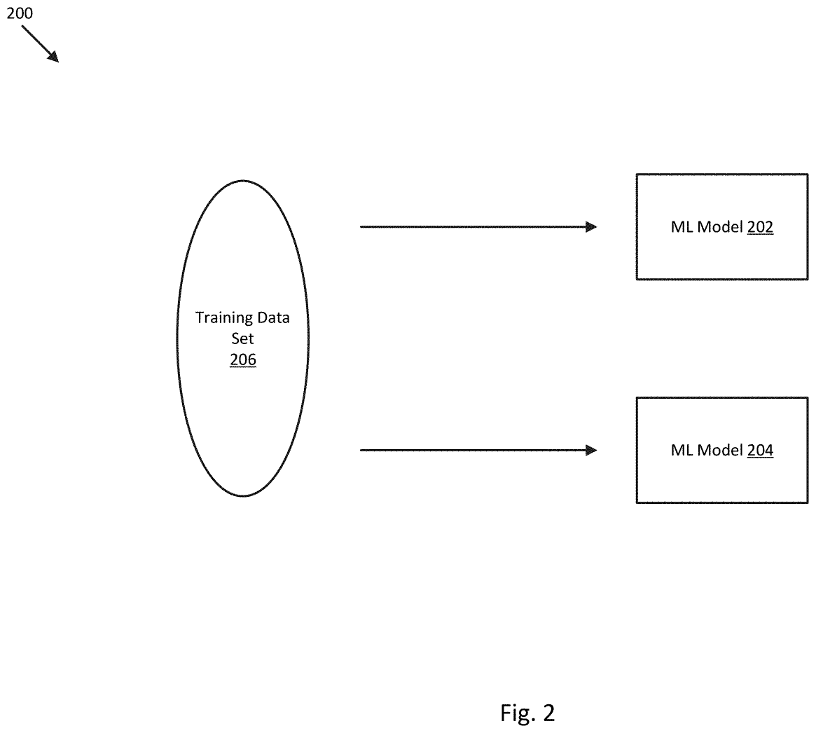

Referring now to FIG. 1, illustrated is a flow diagram of a process 100 for cross-label-correction for learning with noisy labels in accordance with one or more embodiments of the present disclosure. The blocks of process 100 are described herein as occurring in serial, or linearly (e.g., one after another). However, multiple blocks of process 100 may occur in parallel. In addition, the blocks of process 100 need not be performed in the order shown and/or one or more of the blocks of process 100 need not be performed. For explanatory purposes, process 100 is primarily described herein with reference to FIGS. 2-8 but may generally be applied to the other figures of the present disclosure.

It will be appreciated that first, second, third, etc. are generally used as identifiers herein for explanatory purposes and are not necessarily intended to imply an ordering, sequence, or temporal aspect as can generally be appreciated from the context within which first, second, third, etc. are used.

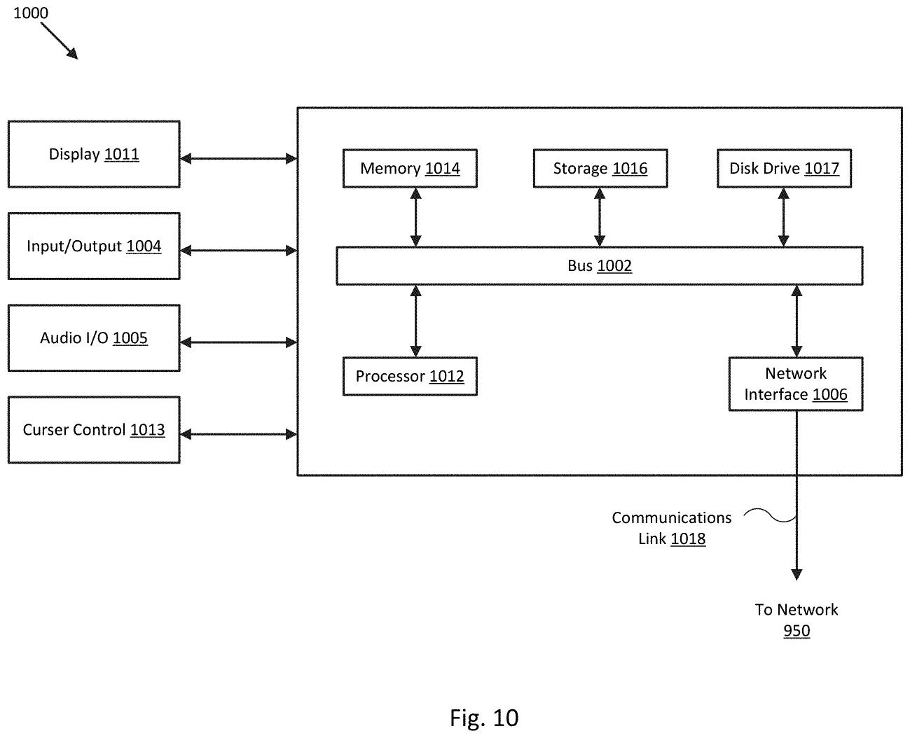

A computer system may perform the operations of processes described in the present disclosure. The computer system may include a non-transitory memory (e.g., a machine-readable medium) that stores instructions and one or more hardware processors configured to read/execute the instructions to cause the computer system to perform the operations of said processes. In various embodiments, the computer system may include one or more computer systems 1000 of FIG. 10.

According to some embodiments, an epoch may be one forward pass and one backward pass of all the training examples (e.g., a data sample and corresponding label) in a training data set. According to some embodiments, a batch size may be the number of training examples in one forward/backward pass. The higher the batch size, the more memory space is generally needed in training. According to some embodiments, a number of iterations may refer to the number of passes, where each pass uses a batch size number of training examples. One pass may equate to one forward pass plus one backward pass (e.g., a forward pass and a backward pass are not counted as two different passes). As an example, if there are 1000 training examples in a training data set, and the batch size is 500, then it will take 2 iterations to complete 1 epoch.

At block 101 of process 100, the computer system may initialize a first machine learning model 202 and a second machine learning model 204, as shown in diagram 200 of FIG. 2. In various embodiments, the machine learning models 202 and 204 may be artificial neural networks, such as deep neural networks, with multiple layers between the input and output layers that allow for modeling complex non-linear relationships. During a training process, internal parameters of the models 202 and 204 (e.g., corresponding to mathematical functions operative on individual neurons of the artificial neural network) may be varied. Outputs from the models 202 and 204 are then compared to known results (e.g., labels), during the training process, to determine one or more best performing sets of internal parameters for the model. In some embodiments, the models 202 and 204 may be trained to predict whether a user account is engaging in fraudulent or legitimate behavior. Thus, many different internal parameter settings may be used for various neurons at different layers to see which settings most accurately predict whether a particular user account is likely to have engaged in a particular user account behavior, such as fraud and/or collusion.

While reference is generally made herein to artificial neural networks, and particularly deep neural networks, the concepts disclosed may generally be applied to other machine learning models.

At block 102 of process 100, and in reference to diagram 200 of FIG. 2, the computer system may train the first machine learning model 202 and the second machine learning model 204 using a training data set 206. In various embodiments, the first machine learning model 202 and the second machine learning model 204 may be trained with the same structure for an initial number of epochs (e.g., a hyperparameter Eᵢ for the training process that defines a number of initial epochs). The number of initial epochs may be limited (e.g., a small number) such that the models 202 and 204 do not overfit to the noisy label data samples in the training data set 206. In some cases, two dataloaders may be created with the training data set 206 using a different random seed for shuffling, so that models 202 and 204 may be trained in parallel.

In some embodiments, where the models are being trained to classify user account activity as fraudulent or legitimate, the training data set 206 may be comprised of user account activity training examples. For example, user account activity data samples may have corresponding labels that indicate whether the user account activity is fraudulent or legitimate. For example, the user account activity may be an electronic transaction, where the electronic transaction has either a label indicating that the electronic transaction is fraudulent or legitimate. In some cases, the training data set 206 may have been automatically generated by an electronic service provider based on aggregated user account activity across the user accounts that are serviced by the electronic service provider.

In some cases, the training data set 206 may have noisy labels associated with its training examples for various reasons, including machine and human error. For example, a user account activity may have been unintentionally or deliberately tagged with a fraudulent label when the user account activity was legitimate, or the user account activity may be unintentionally or deliberately tagged with a legitimate label when the user account activity was fraudulent.

As an illustration, where the electronic service provider facilitates electronic transactions, various entities such as issuing banks, acquiring banks, merchants, and users in peer-to-peer transactions may have reported an electronic transaction as being fraudulent when the electronic transaction was in fact legitimate. The false report may have been captured in the automatic generation of the training data set 206 by the electronic service provider, thus resulting in noisy labels in the training data set 206.

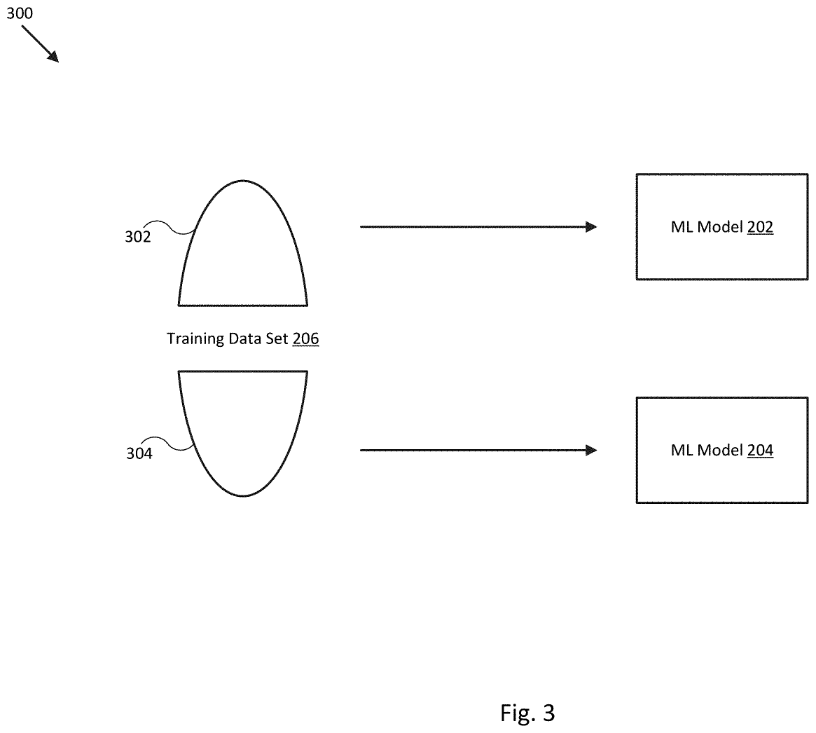

At block 104 of process 100, and in reference to diagram 300 of FIG. 3, the computer system may split the training data set 206 into a first portion 302 and a second portion 304. In some embodiments, the computer system may split the training data set evenly such that the first portion 302 includes half of the training examples from the training data set 206 while the second portion 304 includes the other half of the training examples from the training data set 206. In other embodiments, the computer system may split the training data set 206 unevenly such that the first portion 302 and the second portion 304 include a different number of training examples from the training data set 206. For example, where there is an uneven number of training examples in the training data set 206, one portion may have an additional training example after the training data set 206 is split.

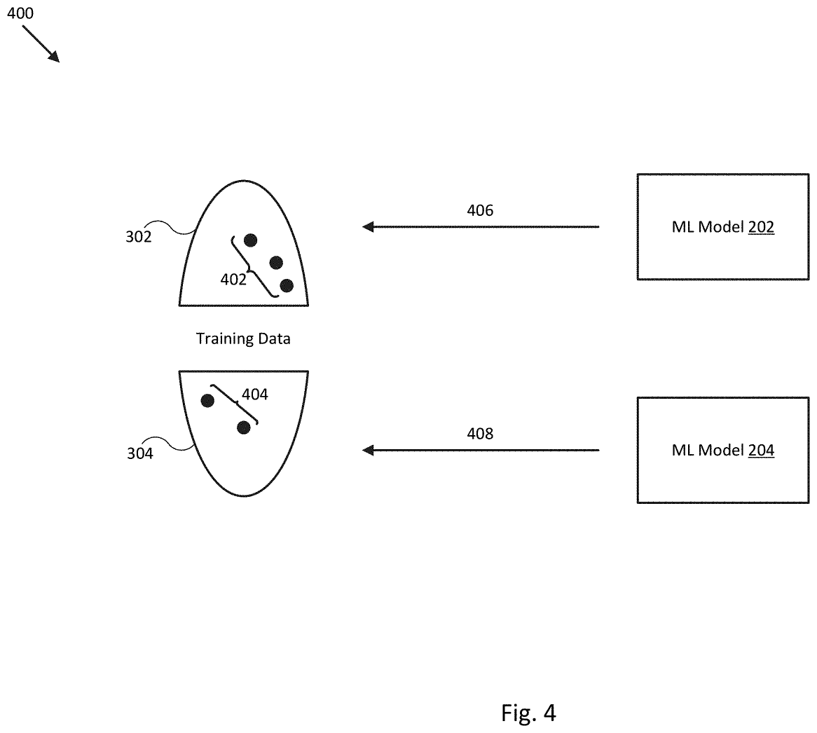

At block 106 of process 100, and in reference to diagram 400 of FIG. 4, the computer system may train the first machine learning model 202 using the first portion 302 of the training data set 206. Similarly, at block 108 of process 100, the computer system may train the second machine learning model 204 using the second portion 304 of the training data set 206.

In some embodiments, the computer system may train the models 202 and 204 at blocks 106 and 108 for a number of half-epochs (e.g., a for loop where for half-epoch eₕ=1, 2, . . . , 2E_{c} perform operations at blocks 106-108, where E_{c} may be a hyperparameter that defines a number of epochs for label correcting iterations).

In other words, the training performed at blocks 106 and 108 should be limited, otherwise overfitting to noisy samples may happen when a model keeps learning wrongly labeled data repeatedly. Thus, in some embodiments, a number of half-epochs before each correction step C may be used for a number iterations in training at blocks 106 and 108 before the cross-label-correction operations at blocks 110-116 are performed.

At block 110, the computer system may run a first prediction using the first machine learning model 202 on the data samples in the first portion 302 of the training data set 206. Similarly, the computer system may run a second prediction using the second machine learning model 204 on the data samples in the second portion 304 of the training data set 206. The computer system may calculate a loss for each sample for which a prediction is made by the first machine learning model 202 and the second machine learning model 204. For example, a loss function may be used to evaluate how well the data samples in the first portion 302 and the second portion 304 are modeled by the first machine learning model 202 and the second machine learning model 206. If the predictions are very inaccurate, the loss function may output a higher number, while if the predictions are fairly accurate, the loss function may output a lower number (or vice versa depending on implementation).

As shown in diagram 400 of FIG. 4, the computer system may select first noisy data samples 402 from the first portion 302 based on their loss values in the first prediction 406 made using the first machine learning model 202. Similarly, the computer system may select second noisy data samples 404 from the second portion 304 based on their loss values in the second prediction 408 made using the second machine learning model 204.

In some embodiments, the computer system may select a percentage number of noisy data samples from the first portion that have the largest loss values. For example, the computer system may select 50% of the data samples from the first portion 302 that have the largest loss values after the first prediction 406. The large loss values may indicate that the original/previous labels for the noisy data samples 402 were likely to have been inaccurate. The computer system may select the second noisy data samples 404 in a similar fashion from the second portion 304. In some embodiments, the percentage number may be a hyperparameter Kₙ % corresponding to an initial noisy sampling rate that decays at a rate relative to the number of correcting epochs E_{c}. In other words, the noisy data sampling rate may decrease during or after each correction iteration as the labels are expected to become cleaner/corrected with each iteration. As one example, the noisy sampling rate may decay according to the following formula: Kₙ′=Kₙe^{-e}^{ₕ}^{/2τ}, where eₕ corresponds to a current epoch relative to a number of epochs E_{c} and τ controls a speed of decay.

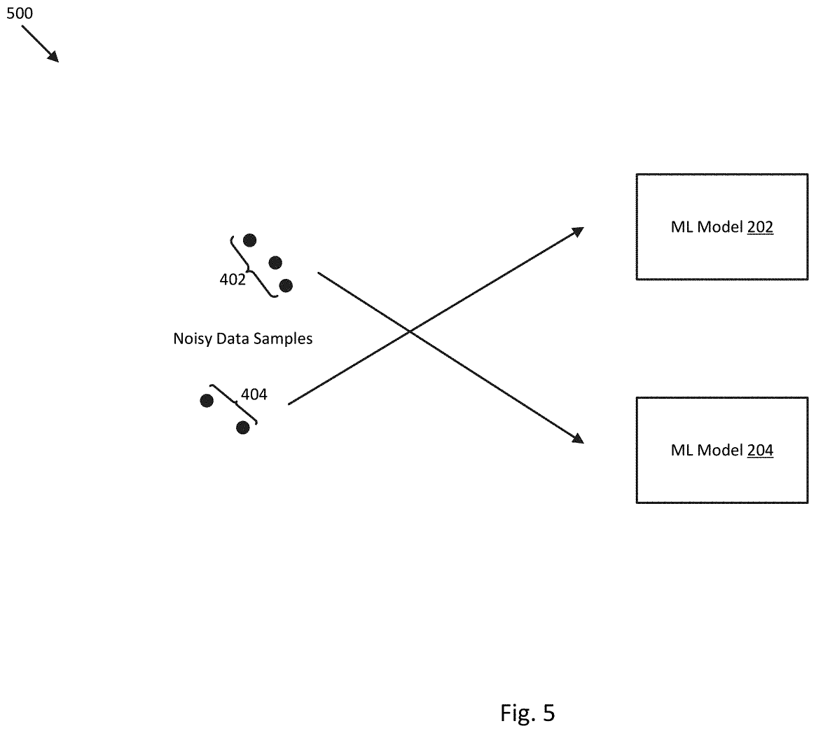

Once the noisy data samples have been identified and selected, the computer system may proceed to blocks 112 and 114 of process 100. At block 112, the computer system may cross-feed (e.g., input) the first noisy data samples 402 to the second machine learning model 204 to be classified, as shown in diagram 500 of FIG. 5. Similarly, the computer system may cross-feed the second noisy data samples 404 to the first machine learning model 202 to be classified.

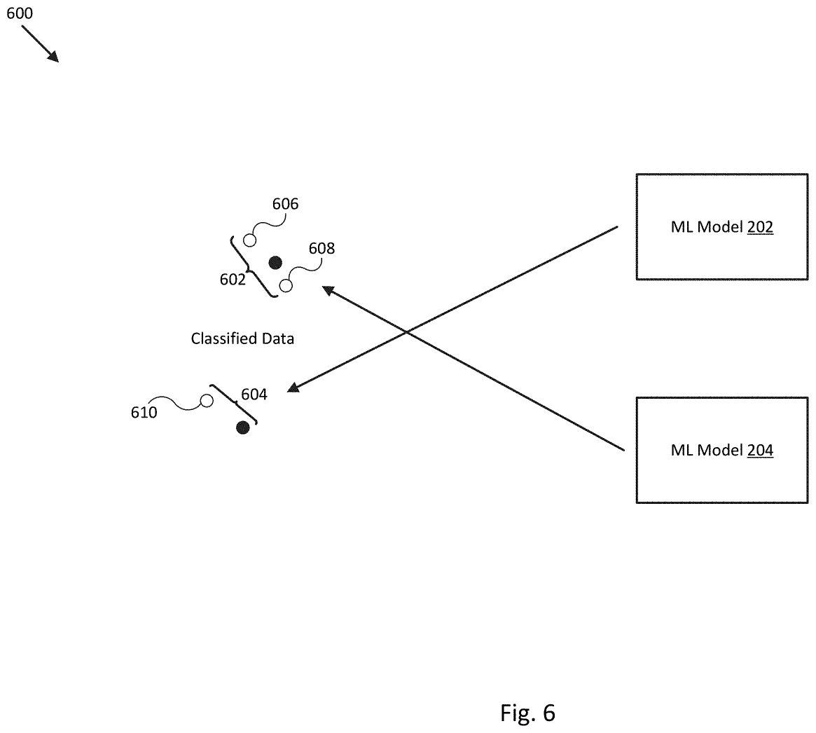

As shown in diagram 600 of FIG. 6, the first machine learning model 202 may classify the second noisy data samples 404 to produce classified data samples 604. Similarly, the second machine learning model 204 may classify the first noisy data samples 402 to produce classified data samples 602.

From the classified data samples 604 and the classified data samples 602, the computer system may identify and select the classified data samples that have the highest confidence scores. In one embodiment, the computer system may select a percentage number K_{c} % from the classified data samples 604 that have the highest confidence scores. Similarly, the computer system may select a percentage number K_{c} % from the classified data samples 602 that have the highest confidence scores. In some embodiments, the percentage number to select from the classified data samples may be a predetermined hyperparameter. As the classified data samples are expected to have noisy original/previous labels, in some implementations it may be safer to set a relatively large number for K_{c} % such as 50% for example. However, K_{c} % may be configured in various implementations to suit the desired application. In the example shown in FIG. 6, data samples 606 and 608 may be identified and selected from the classified data samples 602 and data sample 610 may be selected from the classified data samples 604.

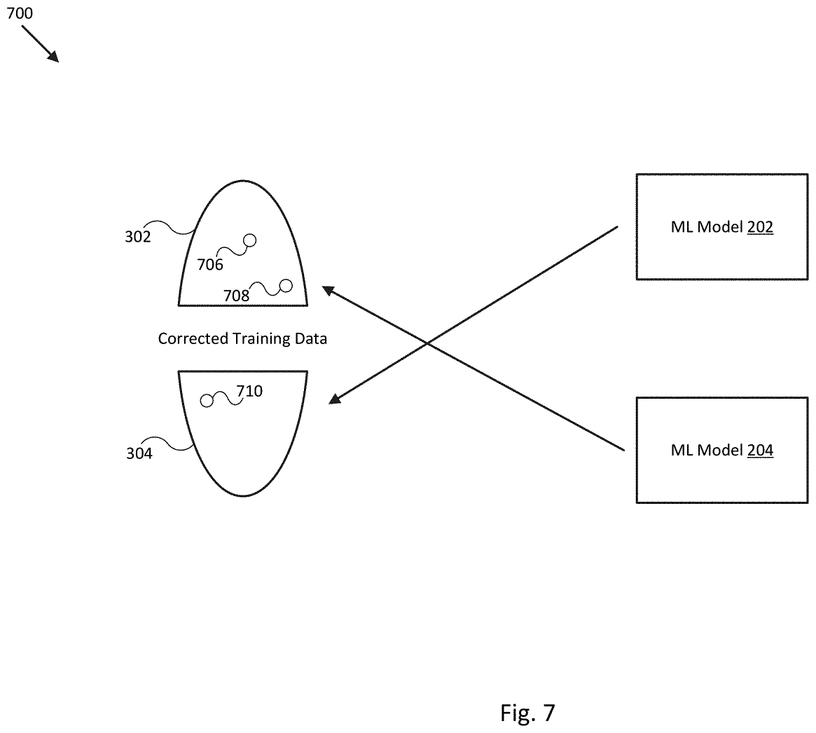

At block 116 of process 100, the computer system may relabel at least one noisy data sample of the first noisy data samples 402 and/or the second noisy data samples 404 based on the classification outputted by the first machine learning model 202 and/or the classification outputted by the second machine learning model 204. For example, as shown in diagram 700 of FIG. 7, the computer system may generate corrected training examples 706 and 708, which may be the noisy data samples corresponding to the classified data samples 606 and 608, but their labels are relabeled with a corrective label determined from the classification of the classified data samples 606 and 608. In other words, certain noisy data samples from the first noisy data samples 402 of FIG. 4 may have their labels relabeled to the corrective labels to generate corrected training examples 706 and 708.

Similarly, the computer system may generate corrective training example 710, which may be the noisy data sample corresponding to the classified data samples 610 that the computer system relabels with a corrective label determined from the classification of the second noisy data samples 404 performed by the first machine learning model 202.

In some embodiments, the relabeling performed at block 116 may be performed using soft labels whereby the noisy data samples may be labeled with soft labels that indicate the degree of membership of the data sample to a given class (e.g., a probabilistic value such as 0.2 or 0.8 as opposed to a hard label value of 0 or 1). In some embodiments, label smoothing may be implemented as would be understood by one of skill in the art.

After the relabeling has been performed, the computer system may repeat the operations at blocks 106 and 108 until C half-epochs have been performed (e.g., eₕ mod C==0), indicating the cross-label-correction at blocks 110-116 should be performed again.

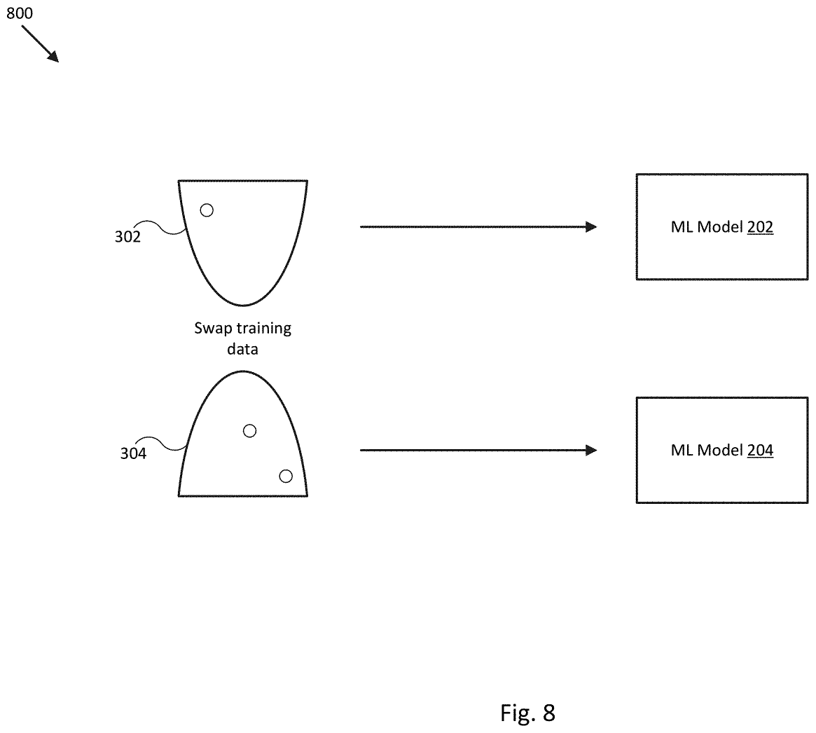

At block 118 of process 100, the computer system may swap the training data examples of the first portion 302 and the second portion 304. As shown in diagram 800 of FIG. 8, once the training data examples have been swapped between the first portion 302 and the second portion 304, the computer system may train the first machine learning model 202 and the second machine learning model 204. The computer system may iterate through the training operations at blocks 106 and 108 again as shown in FIG. 1.

In some embodiments, the computer system may swap the training data examples after a set number of cross-label-corrections S (e.g., operations at blocks 110-116) have been performed (e.g., eₕ mod (C x S)==0). The number of corrections before each swapping of datasets S should not be too large in implementation, otherwise each model 202 and 204 will not see the other half/portion of the training data set 206 for a sufficient number of epochs, which may impair the generalization ability of each model.

As an illustration, the training operations performed at blocks 106-108 may be performed for a certain number of times before the cross-label-correction operations at blocks 110-116 are performed. After the cross-label-correction operations at blocks 110-116 are performed, the computer system may again loop through the training operations at blocks 106-108 until the condition for performing the cross-label-correction operations at blocks 110-116 are met again. The aforementioned loop may continue until a condition for proceeding to the swapping operations at block 118 is met. For example, the swapping operations at block 118 may be performed after operations at blocks 110-116 have been performed for a certain number of times. The computer system may iterate through the aforementioned loops until an end condition is met, such as all of the correcting epochs E_{c} or a multiple thereof (e.g., 2E_{c}), depending on implementation, has been iterated through.

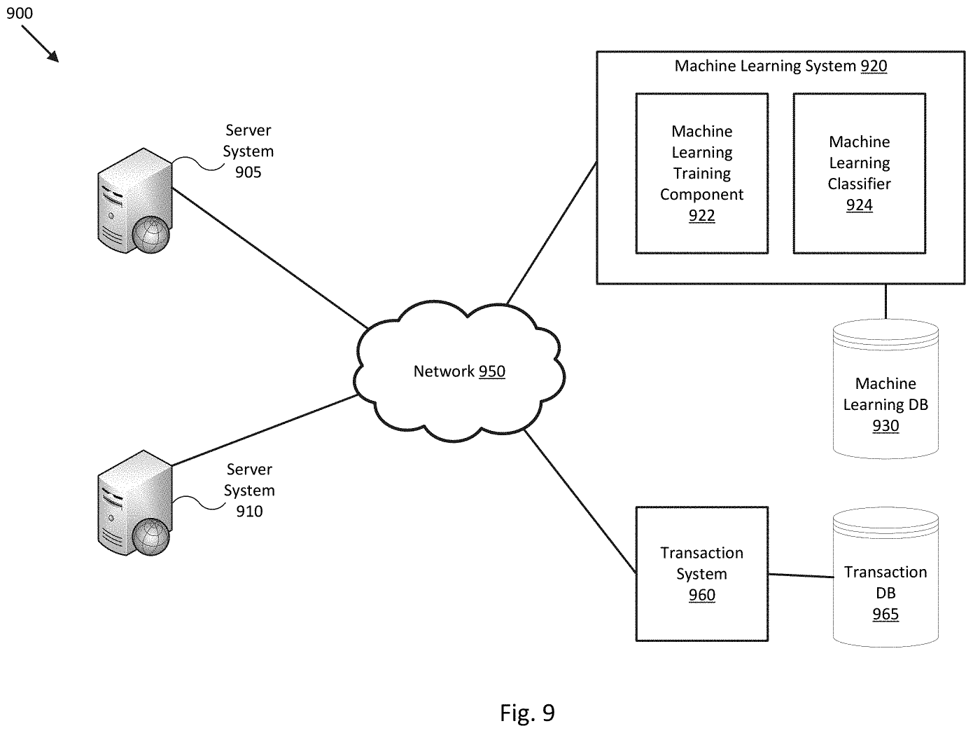

Turning to FIG. 9, a block diagram of a system 900 is shown. In this diagram, system 900 includes server systems 905 and 910, a machine learning system 920, a transaction system 960, and a network 950. Also depicted is transaction database (DB) 965 and machine learning DB 930. Note that other permutations of this figure are contemplated (as with all figures). While certain connections are shown (e.g., data link connections) between different components, in various embodiments, additional connections and/or components may exist that are not depicted. Further, components may be combined with one other and/or separated into one or more systems.

Server systems 905 and 910 may be any computing device configured to provide a service, in various embodiments. Services provided may include serving web pages (e.g., in response to a HTTP request) and/or providing an interface to transaction system 960 (e.g., a request to server system 905 to perform a transaction may be routed to transaction system 960). Machine learning system 920 may comprise one or more computing devices each having a processor and a memory, as may transaction system 960. Network 950 may comprise all or a portion of the Internet.

In various embodiments, machine learning system 920 can perform operations related to training and/or operating a machine learning classifier 924 (using a machine learning training component 922). Both machine learning classifier 924 and machine learning training component 922 may comprise stored computer-executable instructions in various embodiments. Operations performed by machine learning system 920 may include using machine learning techniques to determine whether or not a particular user account has engaged in particular behavior (such as collusion and/or fraud) based on the activities of that account as well as other accounts to which that user account is connected via interaction (such as performing an electronic payment transaction, initiating a dispute or a chargeback, etc.).

Transaction system 960 may correspond to an electronic payment transaction service such as that provided by PayPal™. Transaction system 960 may have a variety of associated user accounts allowing users to make payments electronically and to receive payments electronically. A user account may have a variety of associated funding mechanisms (e.g., a linked bank account, a credit card, etc.) and may also maintain a currency balance in the electronic payment account. A number of possible different funding sources can be used to provide a source of funds (credit, checking, balance, etc.). User devices (smart phones, laptops, desktops, embedded systems, wearable devices, etc.) can be used to access electronic payment accounts such as those provided by PayPal™. In various embodiments, quantities other than currency may be exchanged via transaction system 960, including but not limited to stocks, commodities, gift cards, incentive points (e.g., from airlines or hotels), etc. Transaction system 960 may also correspond to a system providing functionalities such as API access, a file server, or another type of service with user accounts in some embodiments.

Transaction DB 965 includes records related to various transactions taken by users of transaction system 960 in the embodiment shown. These records can include any number of details, such as any information related to a transaction or to an action taken by a user on a web page or an application installed on a computing device (e.g., the PayPal app on a smartphone). Many or all of the records in transaction database 965 are transaction records including details of a user sending or receiving currency (or some other quantity, such as credit card award points, cryptocurrency, etc.). The database information may include two or more parties involved in an electronic payment transaction, date and time of transaction, amount of currency, whether the transaction is a recurring transaction, source of funds/type of funding instrument, and any other details.

FIG. 10 illustrates a block diagram of a computer system 1000 suitable for implementing one or more embodiments of the present disclosure. It should be appreciated that each of the devices utilized by users, entities, and service providers discussed herein (e.g., the computer system) may be implemented as computer system 1000 in a manner as follows.

Computer system 1000 includes a bus 1002 or other communication mechanism for communicating information data, signals, and information between various components of computer system 1000. Components include an input/output (I/O) component 1004 that processes a user action, such as selecting keys from a keypad/keyboard, selecting one or more buttons or links, etc., and sends a corresponding signal to bus 1002. I/O component 1004 may also include an output component, such as a display 1011 and a cursor control 1013 (such as a keyboard, keypad, mouse, etc.). I/O component 1004 may further include NFC communication capabilities. An optional audio I/O component 1005 may also be included to allow a user to use voice for inputting information by converting audio signals. Audio I/O component 1005 may allow the user to hear audio. A transceiver or network interface 1006 transmits and receives signals between computer system 1000 and other devices, such as another user device, an entity server, and/or a provider server via network 950. In one embodiment, the transmission is wireless, although other transmission mediums and methods may also be suitable. Processor 1012, which may be one or more hardware processors, can be a micro-controller, digital signal processor (DSP), or other processing component, processes these various signals, such as for display on computer system 1000 or transmission to other devices via a communication link 1018. Processor 1012 may also control transmission of information, such as cookies or IP addresses, to other devices.

Components of computer system 1000 also include a system memory component 1014 (e.g., RAM), a static storage component 1016 (e.g., ROM), and/or a disk drive 1017. Computer system 1000 performs specific operations by processor 1012 and other components by executing one or more sequences of instructions contained in system memory component 1014. Logic may be encoded in a computer-readable medium, which may refer to any medium that participates in providing instructions to processor 1012 for execution. Such a medium may take many forms, including but not limited to, non-volatile media, volatile media, and transmission media. In various implementations, non-volatile media includes optical or magnetic disks, volatile media includes dynamic memory, such as system memory component 1014, and transmission media includes coaxial cables, copper wire, and fiber optics, including wires that comprise bus 1002. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 1000. In various other embodiments of the present disclosure, a plurality of computer systems 1000 coupled by communication link 1018 to the network 950 (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure.

What is claimed is:

1. A computer system comprising:
a non-transitory memory storing instructions; and
one or more hardware processors configured to execute the instructions and cause the computer system to perform operations comprising:
training a first machine learning model and a second machine learning model using a training data set;
splitting the training data set into a first portion and a second portion;
training the first machine learning model using the first portion of the training data set;
training the second machine learning model using the second portion of the training data set;
inputting one or more first noisy data samples from the first portion of the training data set to the second machine learning model to be classified;
inputting one or more second noisy data samples from the second portion of the training data set to the first machine learning model to be classified; and
relabeling at least one noisy data sample of the first noisy data samples based on a classification outputted by the second machine learning model.

2. The computer system of claim 1, wherein the operations further comprise:
selecting the one or more first noisy data samples from the first portion of the training data set based on a corresponding loss function value for each of the one or more first noisy data samples determined in a classification of the first portion using the first machine learning model; and
selecting the one or more second noisy data samples from the second portion of the training data set based on a corresponding loss function value for each of the one or more second noisy data samples determined in a classification of the second portion using the first machine learning model.

3. The computer system of claim 2, wherein the operations further comprise:
classifying the first portion using the first machine learning model, wherein the one or more first noisy data samples are selected as a percent of samples having a largest loss function value in the classifying using the first machine learning model; and
classifying the second portion using the second machine learning model, wherein the one or more second noisy data samples are selected as a percent of samples having a largest loss function value in the classifying using the second machine learning model.

4. The computer system of claim 1, wherein the operations further comprise:
retraining the first machine learning model using the first portion of the training data set; and
retraining the second machine learning model using the second portion of the training data set, wherein the first portion or the second portion have the at least one noisy sample relabeled for the retraining.

5. The computer system of claim 4, wherein the retraining the first machine learning model, the retraining the second machine learning model are iteratively repeated for a number of epochs, after which, the inputting to the second machine learning model, the inputting to the first machine learning model, and the relabeling are repeated.

6. The computer system of claim 5, wherein a percentage for selection of the one or more first noisy data samples relative to all data samples in the first portion is reduced in each iteration, and wherein a percentage for selection of the one or more second noisy data samples relative to all data samples in the second portion is reduced in each iteration.

7. The computer system of claim 1, wherein the operations further comprise:
identifying one or more first corrective data samples from the classification outputted by the first machine learning model; and
identifying one or more second corrective data samples from the classification outputted by the second machine learning model,
wherein the relabeling comprises:
replacing a noisy label for at least one of the one or more first noisy data samples with a corrective label from the second corrective data samples; and
replacing a noisy label for at least one of the one or more second noisy data samples with a corrective label from the first corrective data samples.

8. A method comprising:
splitting, by a computer system, the training data set into a first portion and a second portion;
training, by the computer system, a first machine learning model using the first portion of the training data set and a second machine learning model using the second portion of the training data set;
classifying, by the computer system and using the first machine learning model, the first portion of the training data set;
selecting, by the computer system, one or more first noisy data samples from the first portion;
classifying, by the computer system and using the second machine learning model, the second portion of the training data set;
selecting, by the computer system, one or more second noisy data samples from the second portion;
classifying, by the computer system and using the first machine learning model, the one or more second noisy data samples;
classifying, by the computer system and using the second machine learning model, the one or more first noisy data samples; and
relabeling at least one noisy sample of the first noisy data samples and at least one noisy sample of the second noisy data samples.

9. The method of claim 8, wherein the selecting the one or more first noisy data samples from the first portion comprises determining a number of noisy data samples from the first portion that have a largest loss value for a loss function that measures a performance of the classifying the first portion using the first machine learning model, and wherein the selecting the one or more second noisy data samples from the second portion comprises determining a number of noisy data samples from the second portion that have a largest loss value for a loss function that measures a performance of the classifying the second portion using the second machine learning model.

10. The method of claim 9, wherein the number of noisy data samples from the first portion and the number of noisy data samples from the second portion are derived from a sampling percentage that decreases with each iteration of the relabeling.

11. The method of claim 8, further comprising swapping, by the computer system, data samples in the first portion and data samples in the second portion after the relabeling.

12. The method of claim 11, further comprising retraining, by the computer system, the first machine learning model using the first portion and the second machine learning model using the second portion after the swapping.

13. The method of claim 8, wherein the at least one noisy sample of the first noisy data samples is relabeled to have a corresponding corrective label outputted from the classification of the first noisy data samples using the second machine learning model, and wherein the at least one noisy sample of the second noisy data samples is relabeled to have a corresponding corrective label outputted from the classification of the second noisy data samples using the first machine learning model.

14. The method of claim 8, wherein the training data set comprises training examples corresponding to electronic service transactions that are labeled as either fraudulent or legitimate.

15. The method of claim 8, wherein the training the first machine learning model and the second machine learning model using the training data set is performed using a predefined number of epochs as a hyperparameter that prevents an initial overfitting to the training data set.

16. A non-transitory machine-readable medium having instructions stored thereon, wherein the instructions are executable to cause a machine of a system to perform operations comprising:
training a first machine learning model using a first portion of a training data set, and a second machine learning model using a second portion of the training data set;
classifying the first portion of the training data set using the first machine learning model;
selecting one or more first noisy data samples from the first portion;
classifying the second portion of the training data set using the second machine learning model;
selecting one or more second noisy data samples from the second portion;
classifying the one or more second noisy data samples using the first machine learning model;
classifying the one or more first noisy data samples using the second machine learning model; and
relabeling at least one noisy sample of the one or more first noisy data samples and at least one noisy sample of the one or more second noisy data samples.

17. The non-transitory machine-readable medium of claim 16, wherein the classifying the one or more second noisy data samples using the first machine learning model results in a first confidence score that exceeds a second confidence score in the classifying, using the second machine learning model, the one or more second noisy data samples as part of the second portion, and wherein the one or more second noisy data samples are relabeled using one or more corresponding corrective label provided by the classifying the one or more second noisy data samples using the first machine learning model.

18. The non-transitory machine-readable medium of claim 17, wherein the classifying the one or more first noisy data samples using the second machine learning model results in a third confidence score that exceeds a fourth confidence score in the classifying, using the first machine learning model, the one or more first noisy data samples as part of the first portion, and wherein the one or more first noisy data samples are relabeled using one or more corresponding corrective label provided by the classifying the one or more first noisy data samples using the second machine learning model.

19. The non-transitory machine-readable medium of claim 16, wherein the operations further comprise swapping data samples from the first portion and data samples from the second portion, wherein the swapping is performed in response to the relabeling having been repeated for a predefined number of iterations.

20. The non-transitory machine-readable medium of claim 16, wherein the training data set comprises electronic service transactional data, and wherein the relabeling comprises relabeling a label corresponding to a fraudulent transaction for at least one noisy sample to a corrective label corresponding to a legitimate transaction.
